(19) United States
(12) Patent Application Publication
(10) Pub. No.: US 2009/0146354 A1
(43) Pub. Date: Jun. 11, 2009

(54) HOLDING TOOL FOR FRAMING

(76) Inventor: George T. Metroyanis, Las Vegas, NV (US)

Correspondence Address: KATTEN MUCHIN ROSENMAN LLP;(C/O PATENT ADMINISTRATOR), 2900 K STREET NW, SUITE 200, WASHINGTON, DC, 20007-5118, US

(21) Appl. No.: 12/167,341

(22) Filed: Jul. 3, 2008

Related U.S. Application Data
(63) Continuation of application No. 11/082,271, filed on Mar. 17, 2005, now abandoned.

(51) Int. Cl. B25B 11/02

(52) U.S. Cl. 269/43; 269/74; 269/66

(57) ABSTRACT

A tool for temporarily holding a second framing member to be fastened into a frame assembly parallel to a first framing member that is already fastened into the assembly. It has a track 1 with a first fixed clamp plate 2 on one end and a second movable clamp plate 11 on the other end; a slide bar 20 mounted on the track between the first and second plates; third 21 and fourth 29 fixed clamp plates on respective ends of the slide; and a clamp closing device 15 that moves the second plate inward toward the fourth plate. A second workpiece 32 between the second and fourth plates will be clamped between them, and will push the slide toward the first plate, simultaneously clamping a first workpiece 31 between the first and third plates.

### BACKGROUND OF THE INVENTION

1. Field of the Invention

This invention relates to clamps for holding two parallel workpieces, especially for holding studs and trusses in alignment for fastening during construction of a building.

2. Description of Prior Art

Prior patents show various types of spacing tools for positioning parallel framing members such as studs and trusses. Some of these tools have two clamps at a desired separation distance along a bar for holding framing members in parallel alignment for installation. However, none of these tools have the primary mechanism of the present invention—an outer bracket with one movable plate and one stationary plate, and an inner bracket that slides within the outer bracket to form two simultaneously opening clamps with a fixed separation distance. None of the prior dual clamp tools provide fully one-handed holding and operation of the tool, including automated opening of the clamps upon pressing a trigger release, as does the preferred embodiment of the present invention.

### SUMMARY OF THE INVENTION

Objectives of this invention include:
providing a tool for temporarily holding a second framing member to be fastened into a frame assembly parallel to a first framing member that is already fastened into the assembly;
providing such a tool that can be held and operated with one hand, including clamping both framing members simultaneously and releasing them simultaneously;
providing such a tool that is lightweight, compact, and inexpensive.

These are met in a holding tool for framing having a track 1 with a first fixed clamp plate 2 on one end and a second movable clamp plate 11 on the other end; a slide bar 20 mounted on the track between the first and second plates; third 21 and fourth 29 fixed clamp plates on respective ends of the slide; and a camp closing device 15 that moves the second plate inward toward the fourth plate. A second workpiece placed between the second and fourth plates will be clamped between them, and will push the slide toward the first plate, simultaneously clamping a first workpiece placed between the first and third plates.

### BRIEF DESCRIPTION OF THE DRAWINGS

FIG. 1 is a perspective view of the invention in an open position accepting two framing members;

FIG. 2 is a perspective view of the invention dosed on two framing members;

FIG. 3 is an exploded view of the invention

FIG. 4 is a perspective view of a second embodiment of the invention.

### REFERENCE CHARACTERS

1. Track
2. First, fixed clamp plate on track
3. Threaded studs for slidable mounting of the slide on the track
4. Stop on track for spring 24 that operates against the slide bar to move third plate 21 away from first plate 2
5. Spring chamber on track for spring 6
6. Spring on track that operates against ratchet bar assembly to move second plate 11 away from fourth plate 29
7. Cap nuts for retention of slide on track
8. Threaded stud on track for slidable mounting of second plate assembly 12 on track
9. Cap nut for slidable mounting of second plate assembly on track
11. Second, slidable clamp plate on track
12. Ratchet bar and second plate assembly
13. Slat in ratchet bar assembly for stud 8
15. Ratchet device fixed to track
16. Fixed handle on ratchet device
17. Movable lever that operates ratchet device by a hand squeeze
18. Ratchet release trigger or button
19. Ratchet bar
21. Third, fixed clamp plate
22. Slots in slide for mounting of slide on track
23. Spring chamber in slide
24. Spring that operates between slide and track to separate plates 2 and 21
25. Spring cover
26. Threaded studs on slide for adjustable mounting of fourth plate
27. Nuts for fixing fourth plate at a selected adjustment position
28. Adjustment slot for adjustable clamp plate
29. Fourth, fixed, preferably adjustable clamp plate
31. First workpiece
32. Second workpiece
34. Retraction of ratchet bar closes both clamp jaws
35. Slide bar moves to close clamp plate 20
41. Screw shaft on second embodiment clamping mechanism
42. Screw shaft turning handle
43. Ball joint receiver portion attached to plate 11
44. Screw shaft threaded boss fixed to track

### DETAILED DESCRIPTION

The invention is a manual tool for holding a framing element such as a wall stud or roof truss in alignment with a previously fastened framing element for fastening into the frame. It comprises three main subassemblies that are slidably attached to each other.

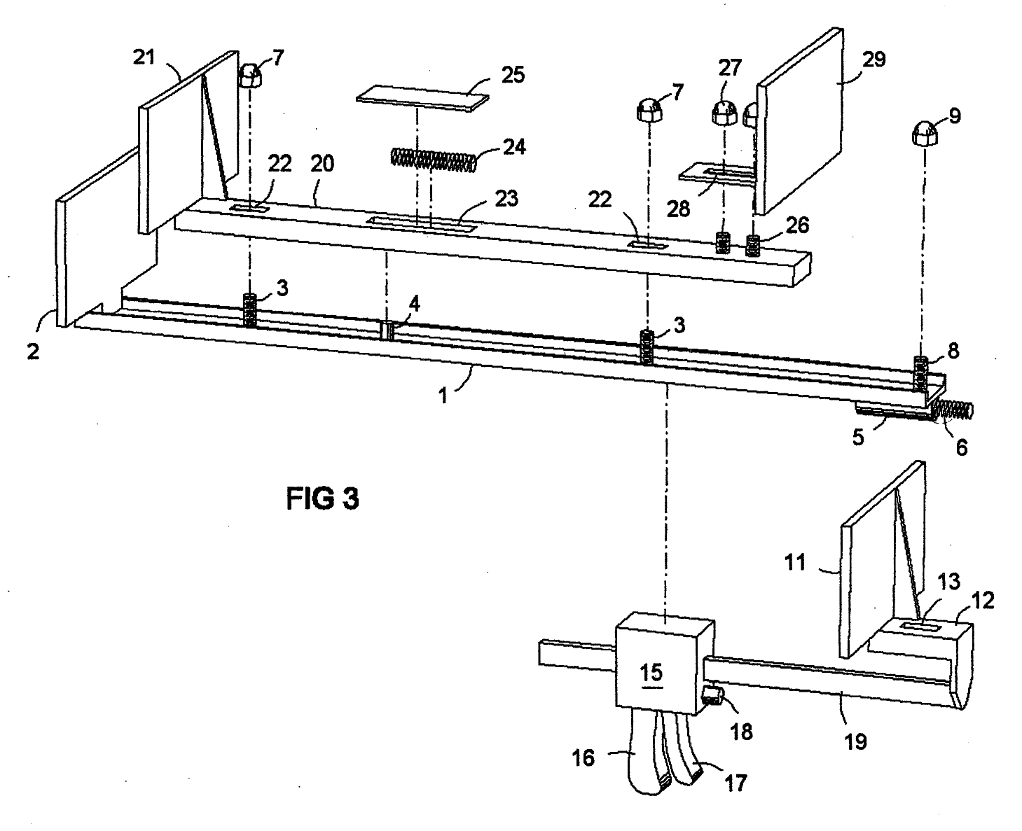

As shown FIG. 3, the first subassembly is a rigid straight track 1 with a fixed clamp plate 2 on one end. The second main subassembly is a movable clamp plate 11 that is slidably mounted on the second end of the tack. This clamp plate is attached to a clamping mechanism, such as a screw rod or preferably a ratchet bar 19. The clamping mechanism moves the second plate inward for a short distance along the track. The third main subassembly is a slide bar 20 that is slidably mounted on the track. It has a fixed clamp plate 21, 31 at each end. One of these 31 is preferably adjustable as to its separation distance from the other. The assembly of these subassemblies forms a pair of clamp plates at each end of the track. Plates 1 and 21 form one pair, and plates 31 and 11 form the second pair.

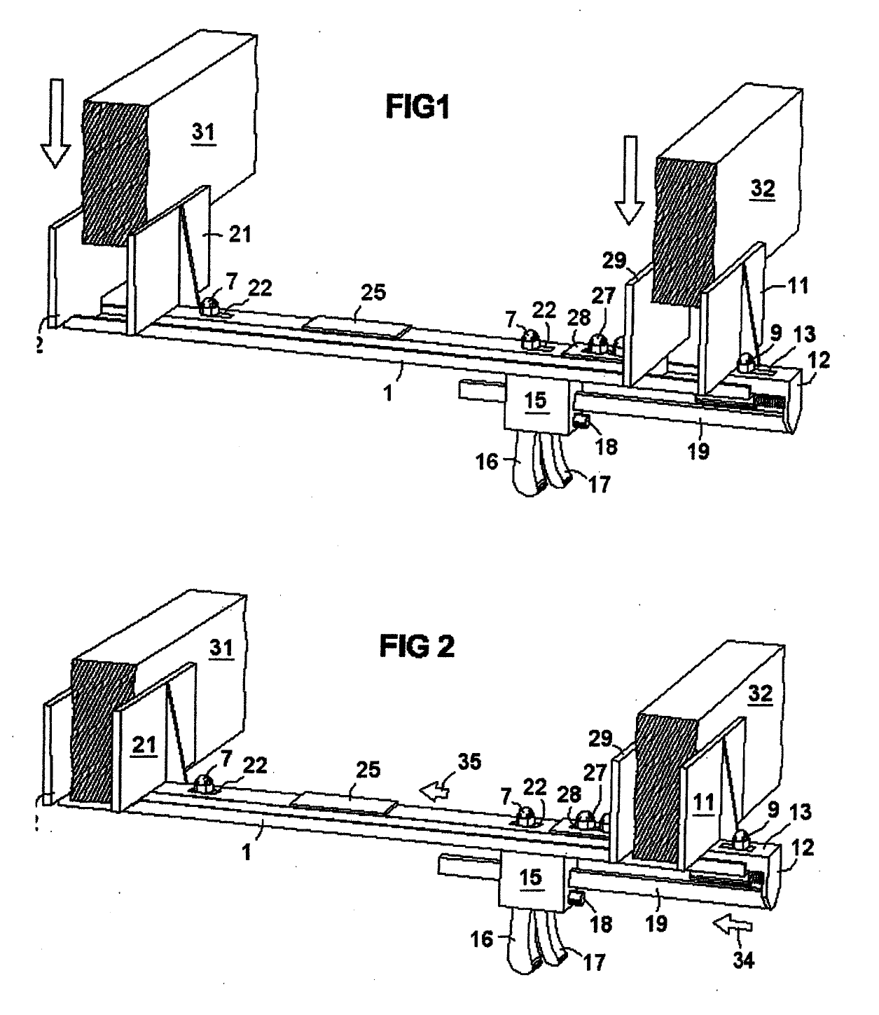

As shown in FIG. 1, a first workpiece 31 is inserted between plates 2 and 21, and a second workpiece 32 is inserted between plates 29 and 11. As shown in FIG. 2, the clamping mechanism is then operated to retract 34 the ratchet bar to move plate II toward plate 29. When the gap between the plates and the second workpiece reaches zero, the second workpiece pushes against plate 29, which pushes the slide bar 20 toward the first end of the track. This action closes the gap between plates 2 and 21 and the first workpiece. When gap around the first workpiece reaches zero, the clamping mechanism tightens the plates on both workpieces. This clamps them simultaneously and securely.

The preferred embodiment of the invention has a squeezable ratchet handle designed for one-handed holding and operation of the tool, as is known in the art of bar clamps. An example of a suitable type of ratchet mechanism is shown in U.S. Pat. No. 5,022,137. The ratchet handle has a stationary handle part 16 and a pivoting handle part 17. The pivoting handle part is operably attached to the ratchet mechanism for stepwise locked linear movement of the ratchet bar through the ratchet mechanism upon repeated manual squeezing of the ratchet handle. A release button or trigger 18 unlocks the ratchet bar so it can slide relatively freely.

Preferably, two springs 6 and 24 are proved to automatically open the clamp jaws when the release button 18 is pressed. A first spring 6 operates between the track 1 and the ratchet bar assembly 12 to move plate 11 away from plate 29. A second spring 24 operates between the track 1 and the slide bar 20 to move plate 21 away from plate 2. These springs automatically open the clamp when the release trigger 18 is pressed. Thus, the user never needs two hands to manipulate the tool. The user always has a free hand to pick up the next worth and place it in position.

The drawings are conceptualized in that they do not show unnecessary details known in the art. For example, plate 2 is fixed to the track 1. This can be done by means of a screw or bolt passing through the tack from below, or by adhesive, welding, by being fabricated integrally with the track, or by any other suitable means. Similarly, plate 21 is fixed to the slide bar 20, and plate 11 is fixed to the ratchet bar assembly 12. The ratchet mechanism 15 is fixed to the track 1. This can be done by screws or bolts passing through the track from above or by any other suitable means. The drawings are oriented for left-handed holding of the tool, leaving the right hand free to lift and position the second workpiece 32. If right-handed holding of the tool is desired, it is simply turned over.

Retention of the sliding parts can be done by other means than threaded studs in slots as shown. For example, the track can be extruded as a C-channel, and the slide bar can be a complementary shape that nests within the channel. The travel of the slide bar should preferably be limited to about half the travel of the ratchet bar assembly. This allows the spring 24 between the track and slide bar to separate plates 2 and 21 to a stopping point, leaving plates 29 and 11 separated by the same amount from the action of spring 6 between the track and the ratchet bar assembly. Travel distances are determined by the length of the slots 22 and 13.

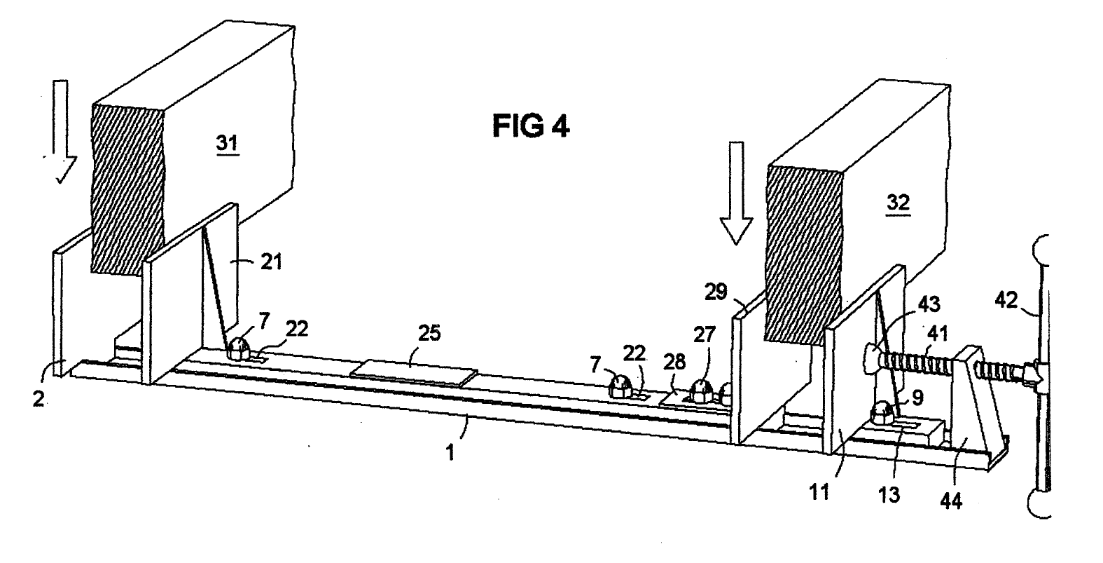

FIG. 4 shows a second embodiment of the invention that uses a screw shaft clamping mechanism 12 as known in the art of clamps. It has a screw shaft 41 with a turning handle 42. The working end of the screw shaft has a ball joint 43 that is attached to plate 11. When the turning handle is turned in one direction, the screw shaft moves plate 11 closer to plate 29. When the turning handle is turned in the other direction, the screw shaft pulls plate 11 away from plate 29.

In the claims, the term ‘outer bracket’ refers to the track 1 and its two plates 2 (fixed) and 29 (movable). The term inner brackets refers to the slide bar 20 and its two fixed plates 21 and 29. “outer”, “outward”, or “outboard” means distally, relative to the length of the tool. “inner”, “inboard”, or “inward” means proximally, relative to the length of the tool.

Although the present invention has been described herein with respect to preferred embodiments, it will be understood that the foregoing description is intended to be illustrative, not restrictive. Modifications of the present invention will occur to those skilled in the art. All such modifications that fall within the scope of the appended claims are intended to be within the scope and spirit of the present invention.

1. A holding tool for framing, comprising:
an outer bracket with first and seconds;
a fixed plate on the first end of the outer bracket;
a movable plate on the second end of the outer bracket;
an inner bracket with first and second ends;
a fixed plate on each end of the inner bracket;
the inner bracket slidably mounted on the outer bracket between the plates of the outer bracket to form two simultaneously clamps with a fixed separation distance; and
a clamping mechanism that slides the movable plate toward the inner bracket.

2. A holding tool for framing, comprising:
a track having first and second ends;
a first clamp plate fixed on the first end of the track;
a second clamp plate slidably mounted on the second end of the track;
a slide bar mounted on the track between the first and second plates, the slide bar having first and second ends adjacent the first and second plates respectively;
a third clamp plate fixed to the first end of the slide;
a fourth camp plate fixed to the second end of the slide; and
a clamp dosing device that moves the second plate toward the fourth plate;
whereby a first workpiece placed between the second and fourth plates will be clamped between them upon operation of the closing device, and the first workpiece will then push the slide bar toward the first plate, which will move the third plate toward the first plate and thus clamp a second workpiece placed between the first and third plates.

3. The holding tool of claim 2, wherein the dosing device is a hand-operated ratchet comprising:
a ratchet mechanism attached to the track;
a ratchet bar slidably mounted through the ratchet mechanism;
a ratchet handle with a fixed gripping portion and a movable lever portion, the movable lever portion operably attached to the ratchet mechanism for stepwise locked linear movement of the ratchet bar through the ratchet mechanism upon repeated manual squeezing of the ratchet handle; and wherein
the second clamp plate is attached to the ratchet bar such that operating the ratchet mechanism moves the second plate toward the fourth plate.

4. The holding tool of claim 3, further comprising:
a first spring that operates between the track and the ratchet bar to separate the second and fourth plates;
a second spring that operates between the track and the slide bar to separate the first and third plates; and
a release trigger on the ratchet mechanism that releases the ratchet bar for relatively free slidable movement through the ratchet mechanism;
whereby the first and third plates will automatically separate and the second and fourth plates will automatically separate by action of the second and first springs respectively upon operation of the release trigger.

5. The holding tool of claim 4, further comprising:
first staining means for mounting the second plate on the track that provides a limited sliding distance for the second plate on the track;
second retaining means for mounting the slide bar on the track that provides a limited sliding distance for the slide bar on the track;
the second retaining means providing approximately half the sliding distance of the first retaining means.

6. The holding tool of claim 2, wherein the clamp dosing device comprises:
a screw shaft threaded boss fixed to the track outboard from the second plate;
a screw shaft threaded through the boss, having an outer end with a turning handle and an inner end with a ball joint attached to the second plate;
whereby turning the handle of the screw shaft moves the second plate inward and outward.

7. A holding tool for framing, comprising:
a track having first and second ends;
a first clamp plate fixed on the first end of the track;
a second clamp plate slidably mounted on the second end of the track;
a slide bar mounted on the track between the first and second plates, the slide bar having first and second ends adjacent the first and second plates respectively;
a third clamp plate fixed to the first end of the slide;
a fourth clamp plate fixed to the second end of the slide; and
a ratchet mechanism attached to the track;
a ratchet bar slidably mounted through the ratchet mechanism;
a ratchet handle with a fixed gripping portion and a movable lever portion, the movable lever portion operably attached to the ratchet mechanism for stepwise locked linear movement of the ratchet bar through the ratchet mechanism upon repeated manual squeezing of the ratchet handle;
the second clamp plate attached to the ratchet bar such that operating the ratchet mechanism moves the second plate toward the fourth plate;
a first spring that operates between the track and the ratchet bar to separate the second and fourth plates;
a second spring that operates between the track and the slide bar to separate the first and third plates;
a release trigger on the ratchet mechanism that releases the ratchet bar for relatively fee slidable movement through the ratchet mechanism;
first retaining means for mounting the second plate on the track that provides a limited sliding distance for the second plate on the track; and
second retaining means for mounting the slide bar on the track that provides a limited sliding distance for the slide bar on the track, the second retaining means providing approximately half the sliding distance of the first retaining means;
whereby a first workpiece placed between the second and fourth plates will be clamped between them upon operation of the ratchet mechanism, and the first workpiece will then push the slide bar toward the first plate, which will move the third plate toward the first plate and thus clamp a second workpiece placed between the first and third plates, and whereby the first and third plates will automatically separate and the second and fourth plates will automatically separate by action of the second and first springs respectively upon operation of the release trigger.
